(19) United States
(12) Patent Application Publication
(10) Pub. No.: US 2019/0079713 A1
(43) Pub. Date: Mar. 14, 2019

(54) IMAGE FORMING APPARATUS, COMMUNICATION METHOD, AND NON-TRANSITORY RECORDING MEDIUM

(71) Applicants: KABUSHIKI KAISHA TOSHIBA, Tokyo (JP); TOSHIBA TEC KABUSHIKI KAISHA, Tokyo (JP)

(72) Inventor: Kaoru Uragami, Mishima Shizuoka (JP)

(21) Appl. No.: 15/698,725

(22) Filed: Sep. 8, 2017

(51) Int. Cl. G06F 3/12; H04N 1/00; H04N 1/10; G06K 9/46

(52) U.S. Cl. CPC G06F 3/1236; G06F 3/1238; G06F 3/1284; G06K 9/4604; H04N 1/00411; H04N 1/10; G06F 3/1203

(57) ABSTRACT

According to one embodiment, there is provided an image forming apparatus including an image reading unit and a communication control unit. The image reading unit reads image information of a read target. The communication control unit performs communication with a portable information processing terminal, based on an encoded image displayed on the portable information processing terminal which is an image based on the image information read by the image reading unit.

### FIELD

Embodiments described herein relate generally to an image forming apparatus, a communication method, and a non-transitory recording medium.

### BACKGROUND

In the related art, an image forming apparatus such as a multifunctional peripheral that forms an image indicated by image information stored in a portable information processing terminal such as a multifunctional mobile phone terminal (smartphone) on a sheet is known.

In such an image forming apparatus, the portable information processing terminal causes the image forming apparatus (that is, own apparatus) to be recognized (specified) on a network. With this, the image forming apparatus communicates with the portable information processing terminal. Then, the image forming apparatus obtains the image information stored in the portable information processing terminal from the portable information processing terminal through the communication. The image forming apparatus forms the image indicated by the obtained image information on a sheet.

Here, there is a case where the portable information processing terminal causes the image forming apparatus to be misrecognized, different from the desired image forming apparatus on the network as a desired image forming apparatus. The misrecognition occurs due to an erroneous operation by a user or the like with respect to the portable information processing terminal. As a result, there is a case where the portable information processing terminal causes an unintended image forming apparatus different from the intended image forming apparatus desired by the user to form an image indicating the image information stored in the portable information processing terminal on the sheet.

### DESCRIPTION OF THE DRAWINGS

FIG. 1 is an external view illustrating an overall configuration example of an image forming apparatus of an embodiment.

FIG. 2 is a diagram illustrating a functional configuration example of the image forming apparatus.

FIG. 3 is a diagram illustrating a functional configuration example of a control unit.

FIG. 4 is a diagram illustrating a functional configuration example of a portable information processing terminal.

FIG. 5 is a diagram illustrating a functional configuration example of a control unit.

FIG. 6 is a diagram illustrating a flow example of a process performed by the image forming apparatus if a read target to be read in an image reading unit is an encoded image.

FIG. 7 is a diagram illustrating an example of an image information reading operation image.

FIG. 8 is a diagram illustrating an example of a target encoded image displayed on the portable information processing terminal.

FIG. 9 is a diagram illustrating a flow example of a process in ACT 114 of processes performed by the image forming apparatus.

FIG. 10 is a diagram illustrating another flow example of the process in ACT 114 of the processes performed by the image forming apparatus.

FIG. 11 is a diagram illustrating a flow example of a modification example of the processes performed by the image forming apparatus if the read target is the encoded image.

FIG. 12 is a diagram illustrating a flow example of a process in which a portable information processing terminal generates the target encoded image.

FIG. 13 is a diagram illustrating a flow example of a process in which the portable information processing terminal transmits selected image information to the image forming apparatus.

### DETAILED DESCRIPTION

In general, according to one embodiment, an image forming apparatus includes an image reading unit and a communication control unit. The image reading unit reads image information of a read target. The communication control unit performs communication with the portable information processing terminal based on an encoded image that is an image displayed on a portable information processing terminal based on the image information read by the image reading unit.

Hereinafter, the image forming apparatus of an embodiment and the portable information processing terminal that performs the communication with the image forming apparatus will be described with reference to the drawings. In each diagram, the same reference numerals are given to the same components. In the following description, as an example of the image forming apparatus, an image forming apparatus 100 will be described. In addition, in the following description, as an example of the portable information processing terminal, a portable information processing terminal MP will be described.

### Details of Image Forming Apparatus

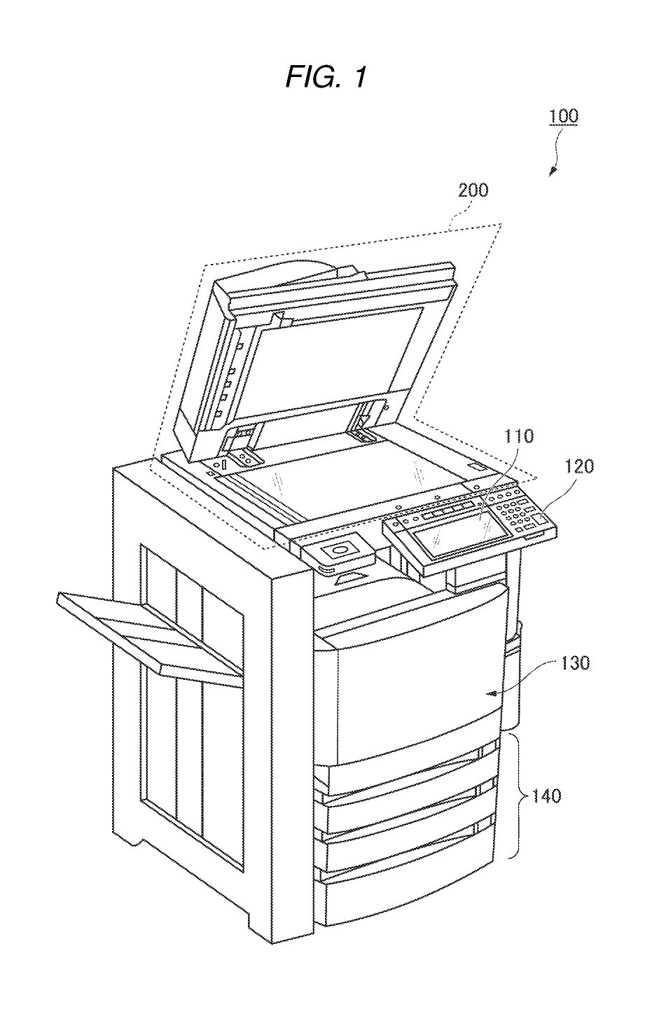

Hereinafter, details of the image forming apparatus 100 will be described with reference to FIG. 1.

FIG. 1 is an external view illustrating an overall configuration example of the image forming apparatus 100 of the embodiment. For example, the image forming apparatus 100 is a multifunction machine. The image forming apparatus 100 includes a display 110, a control panel 120, a printer unit 130, a sheet accommodating unit 140, and an image reading unit 200. The printer unit 130 of the image forming apparatus 100 maybe an electrophotographic type apparatus for fixing a toner image or an ink jet type apparatus.

The image forming apparatus 100 forms an image on a sheet by using a developer such as a toner. For example, the sheet is a paper. The sheet may be anything as long as the image forming apparatus 100 can form an image on the surface of the sheet such as a label sheet.

The display 110 is an image display device such as a liquid crystal display and an organic electroluminescence (EL) display. The display 110 displays various types of information relating to the image forming apparatus 100.

The control panel 120 includes a plurality of buttons. The control panel 120 receives a user's operation. The control panel 120 outputs a signal according to an operation performed by the user to a control unit of the image forming apparatus 100. The display 110 and the control panel 120 may be configured as an integrated touch panel.

The printer unit 130 forms an image on the sheet based on the image information generated by the image reading unit 200 or the image information received through a communication path. For example, the printer unit 130 forms an image by the following process. An image forming unit of the printer unit 130 forms an electrostatic latent image on a photoconductive drum based on the image information. The image forming unit of the printer unit 130 forms a visible image by attaching a developer on the electrostatic latent image. As a specific example of the developer, there is a toner. A transferring unit of the printer unit 130 transfers the visible image on the sheet. A fixing unit of the printer unit 130 performs heating and pressing with respect to the sheet, and thus fixes the visible image on the sheet. The sheet on which the image is formed may be the sheet accommodated in the sheet accommodating unit 140, or may be a sheet that is manually processed.

The sheet accommodating unit 140 accommodates the sheet used for the image formation in the printer unit 130.

The image reading unit 200 reads the image information of the read target based on light and darkness of light. The image reading unit 200 records the read image information. The recorded image information may be transmitted to another information processing apparatus through a network. The recorded image information may be formed as an image on the sheet by the printer unit 130.

### Functional Configuration of Image Forming Apparatus

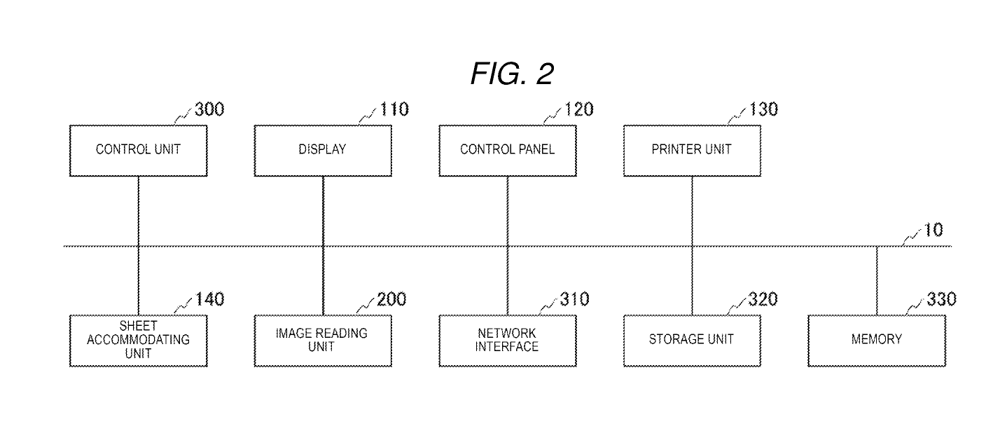

Hereinafter, a functional configuration of the image forming apparatus 100 will be described with reference to FIG. 2.

FIG. 2 is a diagram illustrating a functional configuration example of the image forming apparatus 100.

The image forming apparatus 100 includes a control unit 300, the display 110, and the control panel 120. In addition, the image forming apparatus 100 includes the printer unit 130, the sheet accommodating unit 140, and the image reading unit 200. In addition, the image forming apparatus 100 includes a network interface 310, a storage unit 320, and a memory 330. Respective functional units included in the image forming apparatus 100 are communicably connected to each other through a system bus 10.

Since the description of the display 110, the control panel 120, and the printer unit 130 is the same as the above description, description thereof will be omitted. In addition, since the description of the sheet accommodating unit 140 and the image reading unit 200 is the same as the above description, description thereof will be omitted. Hereinafter, the control unit 300, the network interface 310, the storage unit 320, and the memory 330 will be described.

The control unit 300 includes a central processing unit (CPU) of the image forming apparatus 100. The control unit 300 controls an operation of each functional unit of the image forming apparatus 100. The control unit 300 performs various processes by executing programs. The control unit 300 obtains an instruction that is input by a user through the control panel 120. That is, the control unit 300 receives an operation from the user through the control panel 120. The control unit 300 performs a control process based on the obtained instruction.

The network interface 310 performs transmission and reception of data between another apparatus and the network interface 310. The network interface 310 is operated as an input interface, and receives the data transmitted from another apparatus. In addition, the network interface 310 is operated as an output interface, and transmits the data to another apparatus.

For example, the storage unit 320 is an auxiliary storage device such as a hard disk drive and a solid state drive (SSD). The storage unit 320 stores various types of data.

For example, the memory 330 is a random access memory (RAM). The memory 330 temporarily stores the data used by respective functional units of the image forming apparatus 100. The memory 330 may store the data generated by the image reading unit 200, programs for operating respective functional units, and the like.

### Functional Configuration of Control Unit of Image Forming Apparatus

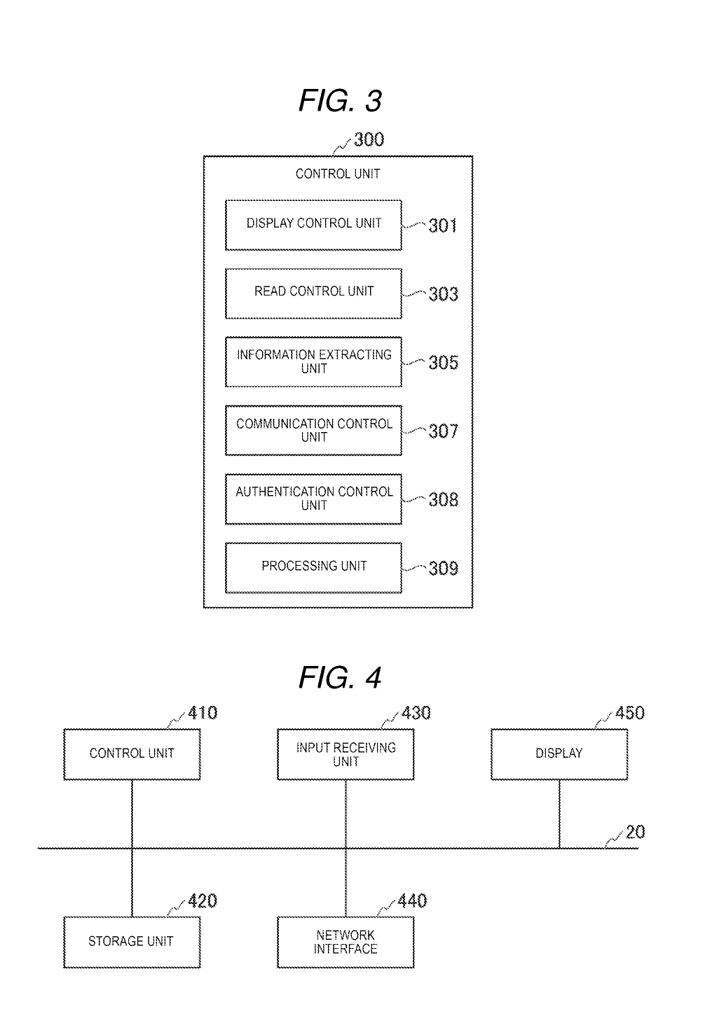

Hereinafter, a functional configuration of the control unit 300 will be described with reference to FIG. 3. FIG. 3 is a diagram illustrating a functional configuration example of the control unit 300.

The control unit 300 includes a display control unit 301, a read control unit 303, an information extracting unit 305, a communication control unit 307, an authentication control unit 308, and a processing unit 309. Some or all of these may be a hardware functional unit such as a large scale integration (LSI) and an application specific integrated circuit (ASIC).

The display control unit 301 generates various images according to an operation received from the user. The display control unit 301 displays the generated images on the display 110.

The read control unit 303 controls the image reading unit 200. The read control unit 303 reads the image information of the read target in the image reading unit 200 based on light and darkness of light. Then, the read control unit 303 converts the read image information into image information of a predetermined format by the image reading unit 200. The predetermined format is a portable document format (PDF). The predetermined format may use another format such as a tag image file format (TIFF) instead of the PDF.

If the image based on the image information that is read by the read control unit 303 is the encoded image, the information extracting unit 305 extracts (decodes) information encoded as the encoded image from the encoded image. For example, the information extracting unit 305 extracts (decodes) the information encoded as the encoded image from the encoded image by optical character recognition (OCR). The encoded image is an image obtained by encoding various types of information. For example, the encoded image is a one-dimensional code such as a bar code. The encoded image may be a two-dimensional code such as a QR code (registered trademark) instead of the one-dimensional code.

The communication control unit 307 performs communication with other apparatuses through the network interface 310.

The authentication control unit 308 performs an authentication process for determining whether or not communication with other apparatuses is permitted.

The processing unit 309 performs an operation corresponding to the operation received from the user of the image forming apparatus 100. In addition, if the image read by the read control unit 303 is the encoded image, the processing unit 309 performs a process based on information extracted by the information extracting unit 305.

### Details of Portable Information Processing Terminal

Hereinafter, details of the portable information processing terminal MP will be described.

For example, the portable information processing terminal MP is a multifunctional mobile phone terminal (smartphone). The portable information processing terminal MP may be a mobile phone terminal, a tablet personal computer (PC), an electronic book reader having a communication function, a personal digital assistant (PDA), a notebook PC, or the like instead of the multifunctional mobile phone terminal.

An application program is installed in the portable information processing terminal MP. The application program performs communication with the image forming apparatus 100. In addition, the application program causes the encoded image corresponding to the operation to be received from the user. In addition, the application program causes one or more pieces of image information corresponding to the operation received from the user to be transmitted to the image forming apparatus 100. In addition, the application program causes the image information generated by the image forming apparatus 100 to be received from the image forming apparatus 100.

The portable information processing terminal MP is connected to be able to communicate with the image forming apparatus 100 each other through wireless communication performed by a communication standard such as Wi-Fi (registered trademark) or wireless communication by a mobile phone communication network. The portable information processing terminal MP may be connected to be able to communicate with the image forming apparatus 100 each other by a cable (that is, wire).

### Functional Configuration of Portable Information Processing Terminal

Hereinafter, a functional configuration of the portable information processing terminal MP will be described with reference to FIG. 4. FIG. 4 is a diagram illustrating a functional configuration example of the portable information processing terminal MP. For example, the portable information processing terminal MP includes a control unit 410, a storage unit 420, an input receiving unit 430, a network interface 440, and a display 450. These configuration elements are connected to be able to communicate with each other through a system bus 20.

The control unit 410 includes a CPU of the portable information processing terminal MP. The control unit 410 controls operations of respective functional units of the portable information processing terminal MP. The control unit 410 performs various types of processes by executing various programs stored in the storage unit 420. The above-described application program is included in the various programs. The control unit 410 obtains an instruction that is input by the user from the input receiving unit 430. That is, the control unit 410 receives an operation from the user through the input receiving unit 430. The control unit 410 performs a control process based on the obtained instruction.

For example, the storage unit 420 includes an auxiliary storage device such as the hard disk and the SSD for storing various types of data, and a memory for temporarily storing data used by respective functional units included in the portable information processing terminal MP such as the RAM. An auxiliary storage device included in the storage unit 420 may be an external auxiliary storage device, instead of being built in the portable information processing terminal MP. In this case, an auxiliary storage device included in the storage unit 420 is connected to the portable information processing terminal MP through a digital input and output port such as a universal serial bus (USB) or the like.

For example, the input receiving unit 430 is a touch panel integrally configured with the display 450 which will be described below. The input receiving unit 430 may be a keyboard, a mouse, a touch pad, or another input device, instead of the touch panel.

The network interface 440 is operated as an input interface, and receives data transmitted from another apparatus. In addition, the network interface 440 is operated as an output interface, and transmits data with respect to another apparatus.

The display 450 is the image display device such as the liquid crystal display and the organic EL display. The display 450 displays various types of information relating to the portable information processing terminal MP.

### Functional Configuration of Control Unit of Portable Information Processing Terminal

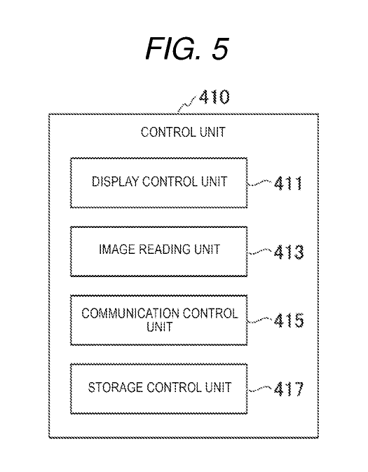

Hereinafter, a functional configuration of the control unit 410 will be described with reference to FIG. 5. FIG. 5 is a diagram illustrating a functional configuration example of the control unit 410.

The control unit 410 includes a display control unit 411, an image read unit 413, a communication control unit 415, and a storage control unit 417. Some or all of these functional units may be hardware functional units such as the LSI and the ASIC.

The display control unit 411 generates various images according to the operation received from the user. The display control unit 411 displays the generated image on the display 450.

The image read unit 413 reads an image corresponding to the operation received from the user among the images stored in the storage unit 420 from the storage unit 420.

The communication control unit 415 performs communication with other apparatuses through the network interface 440.

The storage control unit 417 stores various types of information received from other apparatuses through the network interface 440 in the storage unit 420.

### Process Performed by Image Forming Apparatus in Case Where Read Target is Encoded Image

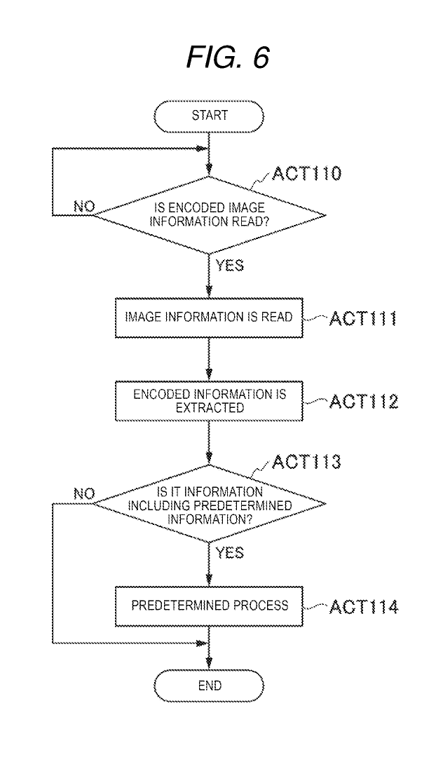

Hereinafter, if the read target to be read in the image reading unit 200 is the encoded image, a flow of a process of the image forming apparatus 100 will be described with reference to FIG. 6. FIG. 6 is a diagram illustrating a flow example of a process performed by the image forming apparatus 100 if the read target to be read in the image reading unit 200 is the encoded image.

The read control unit 303 waits until an encoded image information reading operation is received from the user (ACT 110). The encoded image information reading operation is an operation of causing the image forming apparatus 100 to read the encoded image information which is the image information of the encoded image. For example, the image forming apparatus 100 receives the encoded image information reading operation from the user through the image information reading operation screen. The image information reading operation screen is an image to be displayed on the display 110 by the display control unit 301 according to an operation received from the user. In addition, the image information reading operation screen is an image for selecting an operation mode of the image reading unit 200 by the user. In addition, the image information reading operation screen is an image for receiving an operation, from the user, of causing the image reading unit 200 to read the image information of the read target in an operation mode selected by the user.

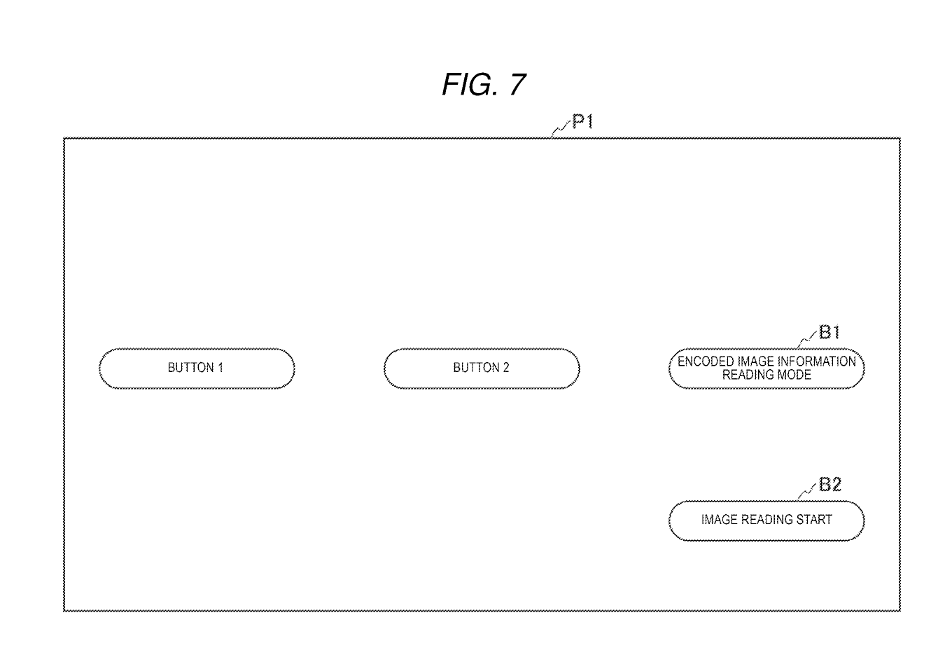

Here, the image information reading operation screen will be described with reference to FIG. 7. FIG. 7 is a diagram illustrating an example of the image information reading operation screen. An image P1 illustrated in FIG. 7 is an example of the image information reading operation screen. The image P1 includes a button B1 and a button B2.

The button B1 is a button for setting (changing) an operation mode of the image reading unit 200 to an encoded image information reading mode. If the user performs a selection operation with respect to the button B1, an operation mode of the image reading unit 200 is set (changed) to the encoded image information reading mode. Here, for example, the selection operation is a click operation, a tap operation, or the like. The encoded image information reading mode is an operation mode optimized for reading the image information of the encoded image as the image information of the read target in the operation modes of the image reading unit 200. That is, in this case, the image reading unit 200 sets (changes) the operation mode of the image reading unit 200 to the encoded image information reading mode.

The button B2 is a button for causing the image reading unit 200 to read the image information of the read target. If the user performs the selection operation with respect to the button B2, the image reading unit 200 reads the image information of the read target. In addition, in this case, the image reading unit 200 reads the image information of the read target according to the operation mode being currently set in the image reading unit 200.

Here, in an example illustrated in FIG. 7, the above-described encoded image information reading operation is an operation of performing the selection operation with respect to the button B2 after performing the selection operation with respect to the button B1. The button B1 and the button B2 may be configured as one button. In this case, the encoded image information reading operation is an operation of performing the selection operation with respect to the one button.

The image P1 may be configured to include other graphical user interfaces (GUI) in addition to the button B1 and the button B2. In the example illustrated in FIG. 7, the image P1 includes two buttons having different functions from the function of each of the button B1 and the button B2 in addition to the button B1 and the button B2. In FIG. 7, the two buttons are displayed as “button 1” and “button 2”, respectively.

If it is determined that the encoded image information reading operation is received from the user (ACT 110: YES), the read control unit 303 causes the image reading unit 200 to read the image information of the encoded image that is the read target (ACT 111).

Here, by causing the image reading unit 200 to read a target encoded image information that is the image information of the target encoded image, the user can perform a predetermined process that is a process determined in advance in the image forming apparatus 100. The predetermined process will be described below. The target encoded image is the encoded image displayed on the portable information processing terminal MP. In addition, the target encoded image is an image in which information including the predetermined information is encoded. The predetermined information is information including identification information and predetermined process request information. The identification information is the identification information of the portable information processing terminal MP. For example, the identification information is an internet protocol (IP) address of the portable information processing terminal MP. The identification information may be another information which can identify the portable information processing terminal MP such as a communicable identifier of a media access control (MAC) address of the portable information processing terminal MP or the like. The predetermined process request information is information indicating a request for performing the predetermined process in the image forming apparatus 100.

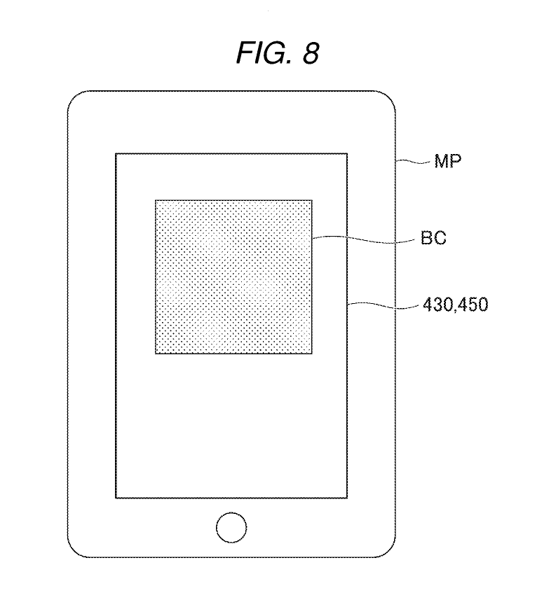

FIG. 8 is a diagram illustrating an example of the target encoded image displayed on the portable information processing terminal MP. An image BC illustrated in FIG. 8 is an example of the target encoded image displayed on the portable information processing terminal MP, that is, the target encoded image displayed on the display 450. As described above, the image BC that is the encoded image is a bar code in this example, but represented by a hatched area in FIG. 8.

Next, the information extracting unit 305 extracts (decodes) the information encoded as the encoded image from the encoded image based on the encoded image information read by the image reading unit 200 in ACT 111 (ACT 112). The encoded image is the encoded image of the read target in ACT 111.

Next, the processing unit 309 determines whether or not the information extracted (decoded) by the information extracting unit 305 in ACT 112 is information including the above-described predetermined information (ACT 113). That is, in ACT 113, the processing unit 309 determines whether or not the encoded image information read by the image reading unit 200 in ACT 111 is the target encoded image information.

If it is determined that the information extracted (decoded) by the information extracting unit 305 in ACT 112 is not the information including the predetermined information (ACT 113: NO), the processing unit 309 completes the process. Meanwhile, if it is determined that the information extracted (decoded) by the information extracting unit 305 in ACT 112 is the information including the predetermined information (ACT 113: YES), the processes of the processing unit 309 and the communication control unit 307 transition to ACT 114. In ACT 114, the processing unit 309 and the communication control unit 307 cause the image forming apparatus 100 to perform the predetermined process (ACT 114). Then, the processing unit 309 completes the process.

### Specific Example 1 of Process in ACT 114

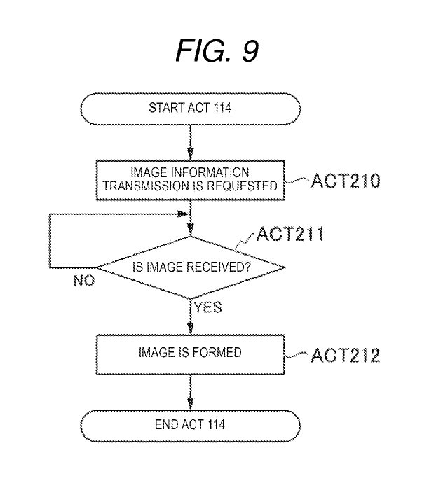

Hereinafter, with reference to FIG. 9, a specific example 1 of the process in ACT 114 of the processes performed by the image forming apparatus 100 will be described. In the specific example 1, the predetermined process is a process of a flowchart illustrated in FIG. 9. That is, in the following description, a case where the encoded image information read by the image reading unit 200 in ACT 111 is the target encoded image information will be described. FIG. 9 is a diagram illustrating a flow example of a process in ACT 114 of the processes performed by the image forming apparatus 100.

The communication control unit 307 transmits image information transmission request information to the portable information processing terminal MP (ACT 210). With this, the communication control unit 307 performs an image information transmission request that is a request for transmitting the image information to the portable information processing terminal MP. That is, the communication control unit 307 performs communication with the portable information processing terminal MP. The image information transmission request information is information indicating a request for transmitting one or more pieces of selected image information to the image forming apparatus 100 in the portable information processing terminal MP. The selected image information is the image information selected by the user in the image information stored in the portable information processing terminal MP. Specifically, the communication control unit 307 transmits the image information transmission request information to the portable information processing terminal MP, based on the identification information included in the information extracted (decoded) by the information extracting unit 305 in ACT 112.

Next, the communication control unit 307 waits until the one or more pieces of selected image information are received from the portable information processing terminal MP, as a response with respect to the image information transmission request information transmitted to the portable information processing terminal MP (ACT 211). That is, the communication control unit 307 receives the one or more pieces of selected image information from the portable information processing terminal MP as the response. If the communication control unit 307 determines that the one or more pieces of selected image information are received from the portable information processing terminal MP as the response (ACT 211: YES), the processing unit 309 performs a process of ACT 212. In ACT 212, the processing unit 309 controls the image forming unit of the printer unit 130, and forms an image on the sheet based on each of the received one or more pieces of selected image information (ACT 212). Then, the processing unit 309 and the communication control unit 307 complete the process in ACT 114. If a plurality of pieces of the selected image information are received from the portable information processing terminal MP in ACT 211, the processing unit 309 forms images in an order on the sheet based on each of the plurality of pieces of the selected image information in ACT 212. The order may be in any order such as an order in which the selected image information corresponding to each of the images is received in the image forming apparatus 100 and a random order.

As described above, the image forming apparatus 100 performs communication with the portable information processing terminal MP, based on the encoded image displayed on the portable information processing terminal MP which is the image based on the read image information by the information extracting unit 305. With this, in the image forming apparatus 100, it is possible to suppress starting of the communication with an unintended portable information processing terminal MP.

In addition, the image forming apparatus 100 extracts information from the encoded image. With this, in the image forming apparatus 100, it is possible to easily receive a request from the portable information processing terminal MP as the information.

In addition, the image forming apparatus 100 performs communication with the portable information processing terminal MP, based on the identification information included in the predetermined information extracted by the information extracting unit 305. With this, in the image forming apparatus 100, it is possible to suppress communication with another portable information processing terminal different from the portable information processing terminal MP due to an erroneous operation.

In addition, the image forming apparatus 100 performs communication with the portable information processing terminal, based on a bar code displayed on the portable information processing terminal MP which is a bar code based on the image information read by the information extracting unit 305. With this, in the image forming apparatus 100, it is possible to suppress the starting of the communication with the unintended portable information processing terminal MP, based on the bar code displayed on the portable information processing terminal MP.

In addition, the image forming apparatus 100 transmits the image information transmission request information to the portable information processing terminal MP in the communication with the portable information processing terminal MP. With this, in the image forming apparatus 100, it is possible to easily transmit the image information stored in the portable information processing terminal MP to own apparatus in the portable information processing terminal MP.

In addition, the image forming apparatus 100 receives the image information from the portable information processing terminal MP as a response with respect to the image information transmission request information, and forms the image on the sheet based on the received image information. With this, in the image forming apparatus 100, it is possible to easily form the image information stored in the portable information processing terminal MP on the sheet.

### Specific Example 2 of Process in ACT 114

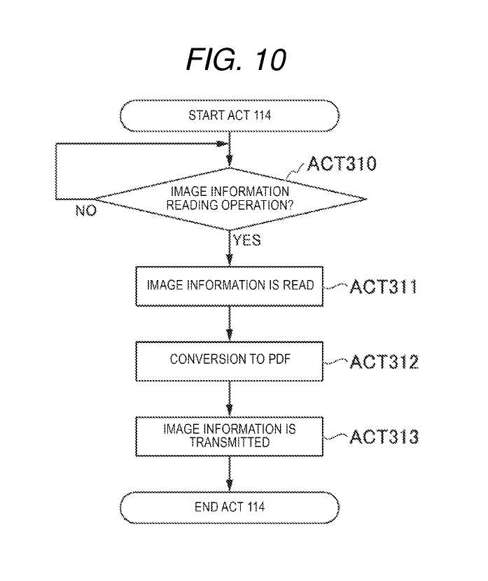

Hereinafter, a specific example 2 of a process in ACT 114 of the processes performed by the image forming apparatus 100 will be described with reference to FIG. 10. In the specific example 2, the predetermined process is a process of a flowchart illustrated in FIG. 10. That is, in the following description, a case where the image information read by the image reading unit 200 in ACT 111 is the image information of the target encoded image will be described. FIG. 10 is a diagram illustrating another flow example of a process in ACT 114 of the processes performed by the image forming apparatus 100.

The read control unit 303 waits until an image information reading operation is received from the user (ACT 310). The image information reading operation is an operation of performing the selection operation with respect to the above-described button B2. That is, the image information reading operation is an operation of causing the image reading unit 200 to read the image information of the read target. In the image information reading operation, an operation mode of the image reading unit 200 may be any operation mode. If the selection operation is performed with respect to the button B2, the read control unit 303 determines that the image information reading operation is received. If it is determined that the image information reading operation is received from the user (ACT 310: YES), the read control unit 303 causes the image reading unit 200 to read the image information of the read target (ACT 311).

Next, the read control unit 303 converts the image information read by the image reading unit 200 in ACT 311 into the image information of PDF (ACT 312).

Next, the communication control unit 307 transmits the image information of PDF converted by the read control unit 303 in ACT 312 to the portable information processing terminal MP (ACT 313). That is, the communication control unit 307 performs communication with the portable information processing terminal MP. Then, the processing unit 309 and the communication control unit 307 complete the process. Here, in the portable information processing terminal MP in which the image information of PDF is received by a process of ACT 313, the storage control unit 417 causes the storage unit 420 to store the image information.

As described above, the image forming apparatus 100 transmits the image information read by the image reading unit 200 to the portable information processing terminal MP in the communication with the portable information processing terminal MP. With this, in the image forming apparatus 100, it is possible to easily transmit the image information read by the image forming apparatus 100 to the portable information processing terminal MP based on the encoded image displayed on the portable information processing terminal MP.

Modification Example of Process Performed by Image Forming Apparatus in Case Where Read target is Encoded Image

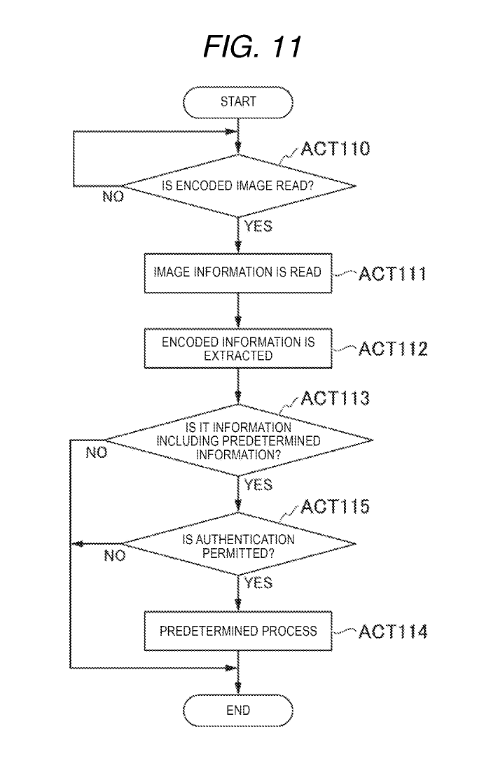

Hereinafter, a flow of a modification example performed by the image forming apparatus 100 if the read target is the encoded image will be described with reference to FIG. 11. In the modification example, the predetermined information includes authentication information of the portable information processing terminal MP. For example, the authentication information of the portable information processing terminal MP is a password. The authentication information may be another information which can be used in the authentication process for determining whether or not the image forming apparatus 100 permits the communication with the portable information processing terminal MP.

FIG. 11 is a diagram illustrating a flow example of a modification example of a process performed by the image forming apparatus 100 in the case where the read target is the encoded image. Since processes of ACT 110 to ACT 113 in FIG. 11 are the same as the processes of ACT 110 to ACT 113 in FIG. 6, description thereof will be omitted. In addition, in FIG. 11, since a process of ACT 114 is the same as the process of ACT 114 in FIG. 6, description thereof will be omitted.

After it is determined that the information extracted by the information extracting unit 305 is the information including the predetermined information in ACT 113, the authentication control unit 308 performs a process of ACT 115. In ACT 115, the authentication control unit 308 determines whether or not the communication with the portable information processing terminal MP is permitted, based on the authentication information included in the predetermined information (ACT 115). For example, the authentication control unit 308 reads the authentication information of the portable information processing terminal MP that is the authentication information stored in advance in the storage unit 420 from the storage unit 420, based on the identification information included in the predetermined information. The authentication control unit 308 determines whether or not the read authentication information and the authentication information included in the predetermined information coincide with each other. Then, if the read authentication information and the authentication information included in the predetermined information do not coincide with each other, the authentication control unit 308 determines that the communication with the portable information processing terminal MP is not permitted. Meanwhile, if the read authentication information and the authentication information included in the predetermined information coincide with each other, the authentication control unit 308 determines that the communication with the portable information processing terminal MP is permitted. If the authentication control unit 308 determines that the communication with the portable information processing terminal MP is not permitted (ACT 115: NO), the processing unit 309 completes the process. Meanwhile, a case where the authentication control unit 308 determines that the communication with the portable information processing terminal MP is permitted (ACT 115: YES), the process of the processing unit 309 transitions to ACT 114, and causes the image forming apparatus 100 to perform the predetermined process.

As described above, the image forming apparatus 100 performs the authentication process determining whether or not the communication with the portable information processing terminal MP is permitted, based on the authentication information. That is, by including the authentication information in the predetermined information, the image forming apparatus 100 can suppress communication with the portable information processing terminal in which the communication is not permitted.

A configuration in which the image forming apparatus 100 performs the authentication process determining whether or not the communication with the portable information processing terminal MP is permitted at another timing may be implemented. In this case, the portable information processing terminal MP transmits the authentication information to the image forming apparatus 100. In addition, in this case, a configuration in which the authentication information may not be included in the predetermined information may be implemented. The another timing is a timing after performing a process of ACT 113 and a timing before performing the process of ACT 114. In addition, the another timing is a timing according to a communication network through which the communication between the image forming apparatus 100 and the portable information processing terminal MP is performed. A type of the communication network is a mobile phone communication network, a Wi-Fi (registered trademark), a local area network (LAN), a wide area network (WAN), the Internet, or the like. For example, a timing before the image P1 illustrated in FIG. 7 is displayed on the display 110 is an example of the another timing if the type is the mobile phone communication network. In this case, the authentication control unit 308 permits the communication with the portable information processing terminal MP such that the display control unit 301 displays the image P1 on the display 110.

### Process of Generating Target Encoded Image by Portable Information Processing Terminal

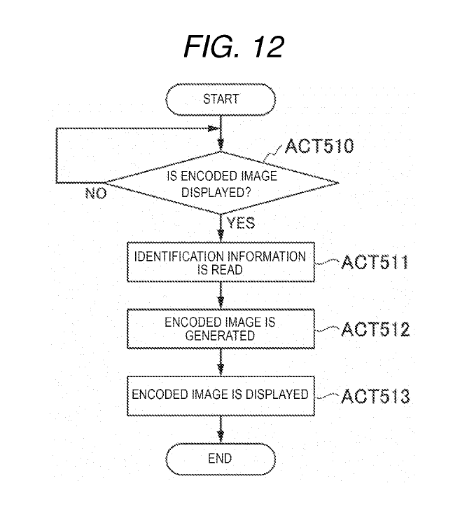

Hereinafter, a flow of a process in which the portable information processing terminal MP generates the target encoded image will be described with reference to FIG. 12. FIG. 12 is a diagram illustrating a flow example of a process in which the portable information processing terminal MP generates the target encoded image.

The display control unit 411 waits until an encoded image display operation is received from the user (ACT 510). The encoded image display operation is an operation of displaying the target encoded image on the portable information processing terminal MP. For example, the display control unit 411 receives the encoded image display operation from the user through an operation image. A target operation image is an image displayed on the display 450 by the display control unit 411 according to an operation received from the user. In addition, the target operation image is one among images for receiving an operation from the user through the portable information processing terminal MP. In addition, the target operation image is an image for receiving the encoded image display operation from the user through the portable information processing terminal MP. If it is determined that the encoded image display operation is received from the user (ACT 510: YES), the display control unit 411 reads the identification information stored in advance in the storage unit 420 from the storage unit 420 (ACT 511). The identification information is the identification information of the portable information processing terminal MP.

Next, the display control unit 411 generates the predetermined process request information. The display control unit 411 generates the target encoded image in which the predetermined information including the identification information read from the storage unit 420 in ACT 511 and the generated predetermined process request information is encoded (ACT 512). A method of generating the target encoded image in which the predetermined information is encoded by the display control unit 411 may be a known method or may be a method developed from the method.

Next, the target encoded image generated in ACT 512 is displayed on the display 450 (ACT 513). Then, the display control unit 411 completes the process.

As described above, the portable information processing terminal MP generates the target encoded image in which information including the identification information of the portable information processing terminal MP and the predetermined process request information is encoded, based on the received operation. In addition, the portable information processing terminal MP displays the generated target encoded image. With this, in the portable information processing terminal MP, it is possible to cause the image forming apparatus 100 to read the target encoded image. As a result, in the portable information processing terminal MP, it is possible to suppress communication with the image forming apparatus 100 different from the desired image forming apparatus 100 due to an erroneous operation or the like. In addition, in the portable information processing terminal MP, it is possible to easily form an image based on the image information stored in the portable information processing terminal MP on the sheet by the desired image forming apparatus 100.

If the predetermined information includes the authentication information, the display control unit 411 reads the authentication information stored in advance in the storage unit 420 from the storage unit 420 at a timing before performing a process of ACT 512. Then, the display control unit 301 generates a predetermined information including the read authentication information, the read identification information, and the generated predetermined process request information in ACT 512.

In addition, a configuration in which information indicating an image based on the image information stored in advance in the storage unit 420 which is the desired image to be formed on the sheet by the image forming apparatus 100 by the user is included in the predetermined information may be implemented. In this case, the image forming apparatus 100 transmits the image information transmission request information and the information to the portable information processing terminal MP in ACT 210 illustrated in FIG. 9. Then, the image forming apparatus 100 receives the image information of the image indicating the information as a response with respect to the image information transmission request information from the portable information processing terminal MP, in ACT 211.

### Process of Transmitting Selected Image Information to Image Forming Apparatus by Portable Information Processing Terminal

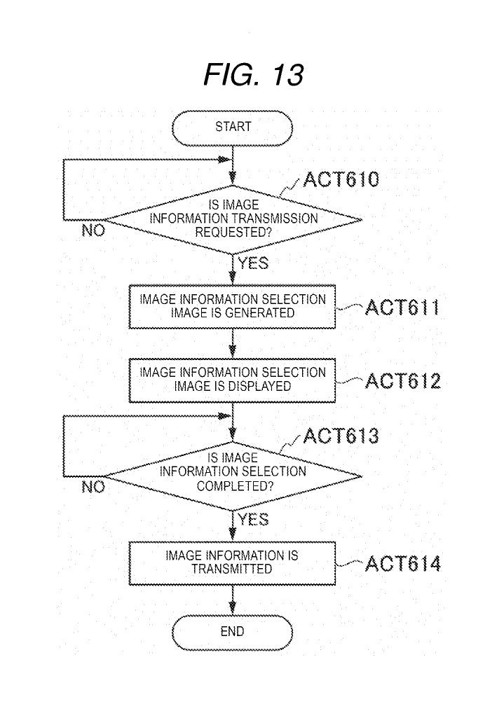

Hereinafter, a flow of a process in which the portable information processing terminal MP transmits the selected image information to the image forming apparatus 100 will be described with reference to FIG. 13. FIG. 13 is a diagram illustrating a flow example of the process in which the portable information processing terminal MP transmits the selected image information to the image forming apparatus 100.

The display control unit 411 waits until the image information transmission request information is received from the image forming apparatus 100 (ACT 610). That is, the display control unit 411 waits until transmission of the image information is requested from the image forming apparatus 100. If it is determined that the image information transmission request information is received from the image forming apparatus 100 (ACT 610: YES), the display control unit 411 generates an image information selection image (ACT 611). The image information selection image is an image for receiving an operation to select a desired image by the user. In addition, the image information selection image is an image displayed based on each of one or more pieces of image information stored in the storage unit 420.

Next, the display control unit 411 causes the display 450 to display the image information selection image generated in ACT 611 (ACT 612).

Next, the communication control unit 415 waits until selection through the image information selection image and selection of one or more pieces of the image information by the user in the image information stored in the storage unit 320 are completed (ACT 613). The user performs the selection operation with respect to a desired image among images indicated in the image information selection image, and thus it is possible to select the image information of the image. If the selection operation is performed with respect to an end button in a state where one or more pieces of image information stored in the storage unit 420 are selected, the communication control unit 415 determines that the selection is completed. The end button is a button for ending the selection in GUIs included in the image information selection image. If it is determined that the selection is completed (ACT 613: YES), the communication control unit 415 performs a process of ACT 614. In ACT 614, the communication control unit 415 transmits one or more pieces of image information selected in ACT 613 to the image forming apparatus 100 (ACT 614). The one or more pieces of the image information are one or more pieces of image information stored in the storage unit 420. Then, the communication control unit 415 completes the process.

As described above, the portable information processing terminal MP can transmit each image information stored in the storage unit 420 which is one or more pieces of image information selected by the user to the image forming apparatus 100, as a response with respect to the image information transmission request information.

As described above, the image forming apparatus 100 reads the image information of the read target. The image forming apparatus 100 performs communication with the portable information processing terminal MP, based on the target encoded image displayed on the portable information processing terminal MP which is the image based on the read image information. With this, in the image forming apparatus 100, it is possible to suppress starting of the communication with the unintended portable information processing terminal MP.

A configuration in which the image forming apparatus 100 described above performs communication with the portable information processing terminal MP based on output information output by the portable information processing terminal MP instead of the target encoded image, may be implemented. The target encoded image is a target encoded image displayed on the portable information processing terminal MP. For example, the output information is information indicated by blinking patterns of light. In addition, the output information is blinking patterns of light indicating information including the identification information identifying the portable information processing terminal MP and the predetermined process request information indicating a request of causing the image forming apparatus 100 to perform a predetermined process. In this case, the image forming apparatus 100 includes an output information reading unit. In this case, the output information reading unit reads patterns of light. In addition, for example, the output information is information expressed by a combination of predetermined sounds. In addition, the output information is the combination indicating the information including the identification information identifying the portable information processing terminal MP and the predetermined process request information indicating the request of causing the image forming apparatus 100 to perform the predetermined process. In this case, the output information reading unit reads a combination of sounds. The output information may be another information such as vibration patterns instead of the blinking patterns of light and the combination of sounds.

While certain embodiments have been described, these embodiments have been presented by way of example only, and are not intended to limit the scope of the inventions. Indeed, the novel embodiments described herein may be embodied in a variety of other forms: furthermore various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. An image forming apparatus comprising:
an image reading unit configured to read image information of a read target; and
a communication control unit configured to perform communication with a portable information processing terminal, based on an encoded image displayed on the portable information processing terminal, the encoded image comprising an image based on the image information read by the image reading unit.

2. The apparatus according to claim 1, further comprising:
an information extracting unit configured to extract the information from the encoded image,
wherein the image comprises encoded information including identification information identifying the portable information processing terminal and predetermined process request information indicating a request of causing the image forming apparatus to perform a predetermined process.

3. The apparatus according to claim 2,
wherein the communication control unit performs communication with the portable information processing terminal, based on the identification information included in the information extracted by the information extracting unit.

4. The apparatus according to claim 1,
wherein the encoded image is a bar code.

5. The apparatus according to claim 1,
wherein the communication control unit transmits image information transmission request information to the portable information processing terminal in the communication.

6. The apparatus according to claim 5, further comprising:
an image forming device configured to form an image based on the image information received by the communication control unit on a sheet,
wherein the communication control unit receives the image information from the portable information processing terminal as a response with respect to the image information transmission request information.

7. The apparatus according to claim 1,
wherein the communication control unit transmits the image information read by the image reading unit to the portable information processing terminal in the communication.

8. The apparatus according to claim 1, further comprising:
an authentication control unit configured to perform an authentication process of determining whether or not communication with the portable information processing terminal is permitted based on authentication information,
wherein the authentication information of the portable information processing terminal is included in the encoded information as the encoded image.

9. A communication method of an image forming apparatus communicating with a portable information processing terminal, comprising:
image reading image information of a read target; and
communicating with the portable information processing terminal, based on an encoded image displayed on the portable information processing terminal, the encoded image comprising an image based on the image information read by the image reading.

10. The communication method according to claim 9, further comprising:
extracting the information from the encoded image,
wherein the image comprises encoded information including identification information identifying the portable information processing terminal and predetermined process request information indicating a request of causing the image forming apparatus to perform a predetermined process.

11. The communication method according to claim 10, further comprising:
communicating with the portable information processing terminal, based on the identification information included in the information extracted from the encoded image.

12. The communication method according to claim 9,
wherein the encoded image is a bar code.

13. The communication method according to claim 9, further comprising:
transmitting image information transmission request information to the portable information processing terminal while communicating.

14. The communication method according to claim 13, further comprising:
receiving the image information from the portable information processing terminal as a response with respect to the image information transmission request information; and
forming an image based on the image information received on a sheet.

15. The communication method according to claim 9, further comprising:
transmitting the image information read to the portable information processing terminal while communicating.

16. The communication method according to claim 9, further comprising:
determining whether or not communication with the portable information processing terminal is permitted based on authentication information,
wherein the authentication information of the portable information processing terminal is included in the encoded information as the encoded image.

17. A non-transitory recording medium storing a program in a computer of a portable information processing terminal to realize:
generating an encoded image comprising encoded information including identification information of the portable information processing terminal and predetermined process request information of causing an image forming apparatus to perform a predetermined process, based on a received operation; and
displaying the generated encoded image.

18. The non-transitory recording medium according to claim 17,
wherein the encoded image is a bar code.

19. The non-transitory recording medium according to claim 17, further comprising:
communicating with the image forming apparatus, based on an encoded image displayed on the portable information processing terminal.

20. The non-transitory recording medium according to claim 17, further comprising:
determining whether or not communication with the image forming apparatus is permitted based on authentication information,
wherein the authentication information is included in the encoded information as the encoded image.
